(19) United States
(12) Patent Application Publication
(10) Pub. No.: US 2025/0018635 A1
(43) Pub. Date: Jan. 16, 2025

(54) RUBBER MEMBER MOLDING APPARATUS

(71) Applicant: Toyo Tire Corporation, Itami-shi (JP)

(72) Inventors: Akira Sasaki, Itami-shi (JP); Hitoshi Nakamoto, Itami-shi (JP)

(73) Assignee: Toyo Tire Corporation, Itami-shi (JP)

(21) Appl. No.: 18/754,803

(22) Filed: Jun. 26, 2024

(30) Foreign Application Priority Data
Jul. 14, 2023 (JP) 2023-116145

(51) Int. Cl. B29C 48/92; B29C 48/00; B29K 21/00; B29L 30/00

(52) U.S. Cl. CPC B29C 48/92; B29C 48/0019; B29C 48/0022; B29C 48/022; B29K 2021/00; B29L 2030/00

(57) ABSTRACT

A rubber member molding apparatus (10) of an embodiment includes an extruding machine (11) that extrudes a long rubber member for a tire forward, upper and lower forming rollers (13, 14) that sandwich the long rubber member extruded from the extruding machine (11), and a molding drum (15) to which the long rubber member moved forward after having passed through a gap (18) between the upper and lower forming rollers (13, 14) is attached. In the rubber member molding apparatus (10), the upper forming roller (13) is disposed forward of the lower forming roller (14).

### CROSS-REFERENCE TO RELATED APPLICATIONS

This application claims the benefit of and priority to Japanese Patent Application No. 2023-116145 filed on Jul. 14, 2023, and the content thereof is incorporated herein by reference in its entirety.

### BACKGROUND OF THE INVENTION

### 1. Field of the Invention

The present invention relates to a rubber member molding apparatus.

### 2. Description of Related Art

As described in JP2022-117154A and JP2022-117161A, there has been known a rubber member molding apparatus including an extruding machine, upper and lower forming rollers disposed forward of the extruding machine, a molding drum disposed forward of the forming rollers, and a holding member disposed between the forming rollers and the molding drum.

In this rubber member molding apparatus, rubber extruded from the extruding machine turns into a rubber strip after having passed between the upper and lower forming rollers. A leading portion of the rubber strip is attached to the molding drum in such a manner that the holding member performs predetermined operation with sucking and holding the rubber strip. Thereafter, the molding drum rotates to wind up the rubber strip.

### SUMMARY OF THE INVENTION

However, in the above-described rubber member molding apparatus, the presence of the holding member leads to a complicated apparatus and an increased size.

For this reason, the present invention is intended to provide a rubber member molding apparatus including an extruding machine, a forming roller, and a molding drum, which is capable of attaching a leading portion of a rubber strip to the molding drum without the need for a holding member between the forming roller and the molding drum.

The present invention includes embodiments below.

[1] A rubber member molding apparatus including an extruding machine extrudes a long rubber member forward, upper and lower forming rollers that sandwich the long rubber member extruded from the extruding machine, and a molding drum to which the long rubber member moved forward after having passed through a gap between the upper and lower forming rollers is attached and on which the long rubber member turns into a cylindrical rubber member for a tire, in which the upper forming roller is disposed forward of the lower forming roller.

[2] The rubber member molding apparatus according to [1], in which the outer peripheral surfaces of the upper and lower forming rollers are in such a relationship that the long rubber member having passed through the gap between the upper and lower forming rollers is attached to the outer peripheral surface of the upper forming roller.

[3] The rubber member molding apparatus according to [1] or [2], which further includes a temperature adjustment device that adjusts the outer peripheral surface of the lower forming roller to a temperature higher than that of the outer peripheral surface of the upper forming roller.

According to the above-described rubber member molding apparatus, the leading portion of the rubber strip can be attached to the molding drum without the need for the holding member between the forming roller and the molding drum.

### BRIEF DESCRIPTION OF THE DRAWINGS

FIG. 1 is a view of a rubber member molding apparatus in a right-left direction;

FIG. 2 is a view of upper and lower forming rollers from back;

FIG. 3 is a view of a portion from a gear pump to a molding drum from above;

FIG. 4 is a view of the portion from the gear pump to the molding drum in the right-left direction when the forming rollers are at attaching positions;

FIG. 5 is a view of the portion from the gear pump to the molding drum in the right-left direction when a pressing roller is at a pressing position;

FIG. 6 is a view of a nozzle and the forming rollers in the right-left direction;

FIG. 7 is a plan view of a leading portion of a rubber strip before the leading portion is attached to the molding drum and after the leading portion has passed through the forming rollers;

FIG. 8 is a plan view of the leading portion of the rubber strip in a state of the leading portion of the rubber strip being attached to the molding drum;

FIG. 9 is a view of the molding drum from the outside in a radial direction immediately after the leading portion of the rubber strip has been attached to the molding drum;

FIG. 10 is a view of the molding drum from the outside in the radial direction after one or more turns of the rubber strip have been attached;

FIG. 11 is a view of the molding drum from the outside in the radial direction after most part of the rubber strip has been attached;

FIG. 12 is a view of the molding drum from the outside in the radial direction after a trailing portion of the rubber strip has been attached; and

FIG. 13 is a view of forming rollers of a modification from back.

### DESCRIPTION OF EMBODIMENTS

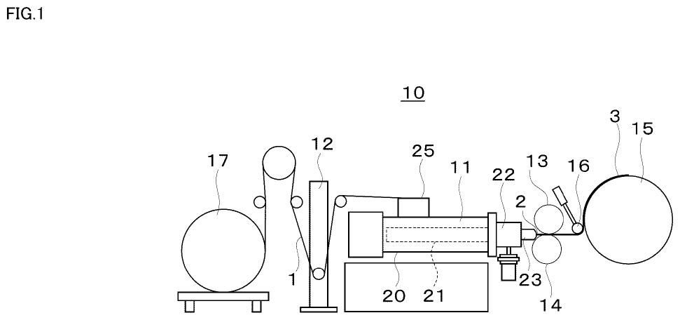

As shown in FIG. 1, a rubber member molding apparatus 10 of the present embodiment includes an extruding machine 11 that extrudes extrusion rubber 2, a let-off device 12 located in the course of supplying a raw rubber sheet 1 which is a raw material of the extrusion rubber 2 to the extruding machine 11, upper and lower forming rollers 13, 14 forming the extrusion rubber 2 extruded from the extruding machine 11 into a rubber strip 3 by sandwiching the extrusion rubber 2 from above and below, a molding drum 15 to which the rubber strip 3 having passed through the forming rollers 13, 14 is attached, a pressing roller 16 that presses the rubber strip 3 attached to the molding drum 15, and a not-shown controller that controls the rubber member molding apparatus 10.

Any of the raw rubber sheet 1, the extrusion rubber 2, and the rubber strip 3 is an unvulcanized long rubber member. In description below, the section of the long rubber member indicates a section perpendicular to a long rubber member extension direction.

In description below, a side on which the molding drum 15 is located will be referred to as a front, and a side on which the let-off device 12 is located will be referred to as a back. The raw rubber sheet 1, the extrusion rubber 2, and the rubber strip 3 move forward in the rubber member molding apparatus 10. A right-left direction is an expression when the rubber member molding apparatus 10 is viewed from the front. The right-left direction is coincident with the axial directions of the molding drum 15 and the forming rollers 13, 14.

The let-off device 12 has a well-known structure, and has a function of adjusting tension on the raw rubber sheet 1 and a function of detecting disconnection of the raw rubber sheet 1 when the raw rubber sheet 1 is disconnected. A bobbin 17 around which the raw rubber sheet 1 is wound is disposed in back of the let-off device 12. The raw rubber sheet 1 pulled out of the bobbin 17 is sent to the extruding machine 11 by way of the let-off device 12.

The extruding machine 11 is a supply device that supplies the extrusion rubber 2 to the molding drum 15, and has a general structure as a rubber extruding machine. The extruding machine 11 includes a cylindrical hollow barrel 20, a rotatable screw 21 provided inside the barrel 20, and an inlet 25 for injecting the raw rubber sheet 1 into the barrel 20.

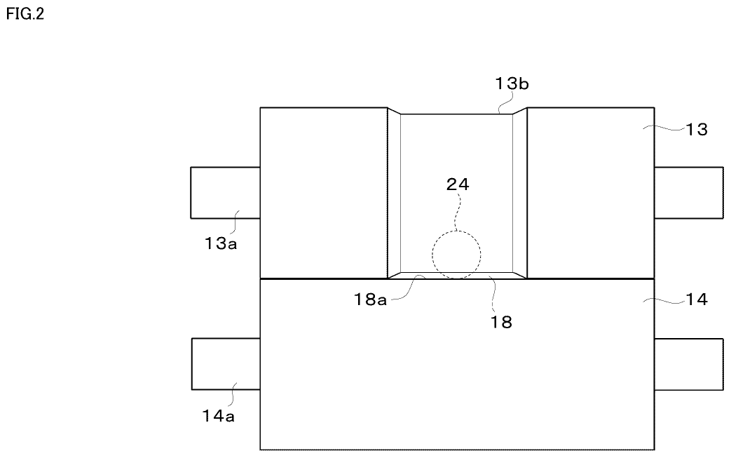

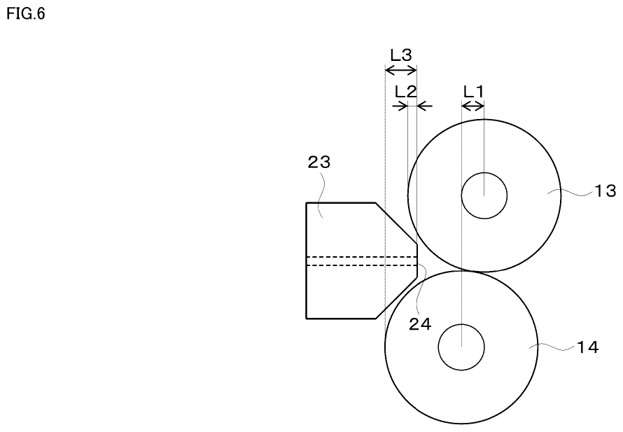

Further, the extruding machine 11 includes, forward of the screw 21, a gear pump 22 and a nozzle 23 as part of the extruding machine 11. The gear pump 22 is attached to the front end of the barrel 20. The gear pump 22 includes two gears engaging with each other, and the rubber flows forward by rotation of these gears. The nozzle 23 is provided at the front end of the gear pump 22. At the nozzle 23, an opening end 24 (see FIGS. 2 and 6) which is the front end of a rubber flow path in the nozzle 23 and a rubber extruding port is formed. The opening end 24 is the front end of the entirety of the extruding machine 11. The amount of rubber extruded from the opening end 24 is determined by the rotation speeds of the gears of the gear pump 22. Here, the extruding amount indicates the volume of rubber extruded from the opening end 24 per unit time.

When the screw 21 rotates and the gear pump 22 is driven, the raw rubber sheet 1 injected through the inlet 25 is horizontally extruded as the extrusion rubber 2 from the opening end 24 of the nozzle 23. As shown in FIG. 2, the opening end 24 of the nozzle 23 is in a circular shape as viewed in a front-back direction. Here, the circular shape includes not only an exact circle but also a shape which can be approximated as a substantially circular shape, such as an oval whose length of the major axis is 110% or less of the length of the minor axis and a regular polygonal shape with 12 or more corners.

Moreover, the opening end 24 of the nozzle 23 is disposed forward of the back end of at least one of the upper and lower forming rollers 13, 14, and in the present embodiment, is disposed between the upper and lower forming rollers 13, 14. Specifically, as shown in FIG. 6, the opening end 24 of the nozzle 23 is located forward of the rear end of the upper forming roller 13 by a distance L2 and forward of the rear end of the lower forming roller 14 by a distance L3.

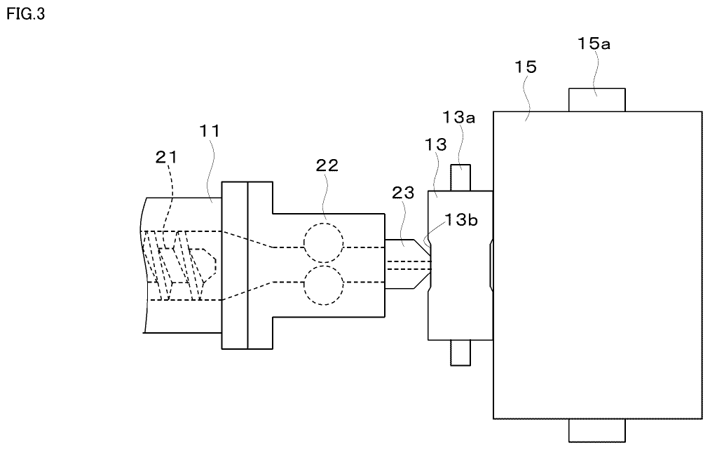

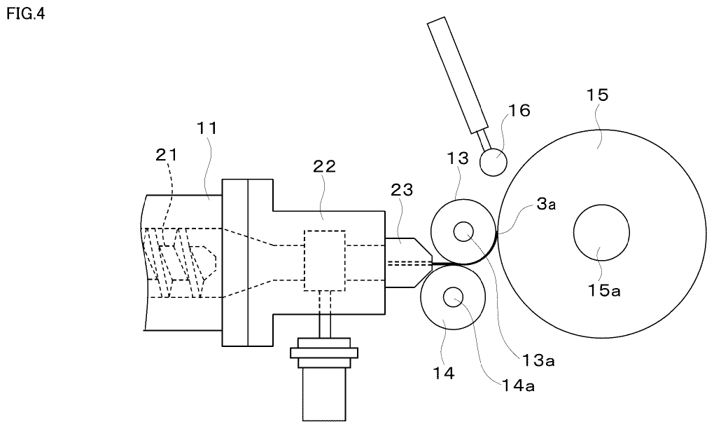

Each of the upper and lower forming rollers 13, 14 is a substantially-cylindrical roller. The upper and lower forming rollers 13, 14 have the same radius. Rotation axes 13a, 14a (see FIGS. 2 to 4) of the upper and lower forming rollers 13, 14 are parallel with a rotation axis 15a (see FIGS. 3 and 4) of the molding drum 15. The center of rotation of the upper forming roller 13 about the rotation axis 13a is preferably at the same height as the center of rotation of the molding drum 15 about the rotation axis 15a.

As shown in FIGS. 4 to 6, the upper forming roller 13 is disposed forward of the lower forming roller 14. A distance L1 (see FIG. 6) in the front-back direction between the rotation axis 13a of the upper forming roller 13 and the rotation axis 14a of the lower forming roller 14 is, for example, ½ of the radius of the forming roller 13, 14 or less. Here, the distance between the rotation axis and the rotation axis precisely indicates a distance between the centers of rotation about the rotation axes.

As shown in FIG. 2, the upper and lower forming rollers 13, 14 contact (line contact) each other on both sides in the right-left direction. On the other hand, at the center in the right-left direction, a gap 18 is formed between the upper and lower forming rollers 13, 14. The gap 18 is formed between a recess 13b formed so as to extend around the entire circumference of the outer peripheral surface of the upper forming roller 13 and the outer peripheral surface of the lower forming roller 14 in the cylindrical shape. The gap 18 is a location where the extrusion rubber 2 enters, is crushed from above and below, and is formed into the rubber strip 3. Thus, the shape of the gap 18 is a target sectional shape of the rubber strip 3. Moreover, the gap 18 is a supplier that faces the outer peripheral surface of the molding drum 15 and supplies the rubber strip 3 to the molding drum 15.

Note that both right and left portions of the upper forming roller 13 with respect to the gap 18 have a constant radius. The lower forming roller 14 has one curved outer peripheral surface, and has a constant radius from one side to the other side in the right-left direction.

The shape of the gap 18 as viewed in the front-back direction is wide in an upper-lower direction at the center in the right-left direction, is narrow in the upper-lower direction on each side in the right-left direction, and has a longer length in the right-left direction than a height in the upper-lower direction. Specifically, the shape of the gap 18 is a trapezoidal shape having a low height. The gap 18 is preferably configured such that the length (length of a longer bottom 18a) in the right-left direction is 20 times or more and 40 times or less the height in the upper-lower direction.

As viewed in the front-back direction, the area of the opening end 24 of the nozzle 23 is twice or more and five times or less the area of the gap 18. Note that the area of the gap 18 indicates the area of the gap 18 on a plane connecting the rotation axes 13a, 14a of the upper and lower forming rollers 13, 14 to each other. Note that the plane connecting the rotation axes 13a, 14a of the upper and lower forming rollers 13, 14 to each other is a plane passing through a position at which the upper and lower forming rollers 13, 14 are in line contact with each other. As shown in FIG. 2, the center (circle center) of the opening end 24 of the nozzle 23 is at a position higher than the bottom 18a of the gap 18.

The outer peripheral surfaces of the upper and lower forming rollers 13, 14 are made of metal. A temperature adjustment device (not shown) that adjusts a temperature such that the outer peripheral surface of the lower forming roller 14 is at a temperature higher than that of the outer peripheral surface of the upper forming roller 13 is provided. The temperature adjustment device includes a heating element provided inside at least the lower forming roller 14 of the upper and lower forming rollers 13, 14 or a heating element disposed closer to the lower forming roller 14 than the upper forming roller 13. Further, the temperature adjustment device further includes a device that controls heat generation by the heating element.

By the temperature adjustment device, the outer peripheral surface of the lower forming roller 14 has the temperature higher than that of the outer peripheral surface of the upper forming roller 13. With such a temperature relationship, the outer peripheral surface of the upper forming roller 13 has higher adhesion to the long rubber member than that of the outer peripheral surface of the lower forming roller 14. Further, since the outer peripheral surface of the upper forming roller 13 has the temperature lower than that of the outer peripheral surface of the lower forming roller 14, the upper side of the long rubber member has a lower temperature than that of the lower side and contracts and the long rubber member warps upward. With these two properties, the rubber strip 3 having passed through the gap 18 between the upper and lower forming rollers 13, 14 is attached to the outer peripheral surface of the upper forming roller 13.

Not-shown two motors are disposed near the upper and lower forming rollers 13, 14, and each of the upper and lower forming rollers 13, 14 is connected to one motor. By driving each motor, the upper and lower forming rollers 13, 14 are rotatable. The rotation speeds of the upper and lower forming rollers 13, 14 are independently adjustable. The rotation direction of the upper forming roller 13 and the rotation direction of the lower forming roller 14 are opposite directions of feeding the long rubber member sandwiched therebetween forward.

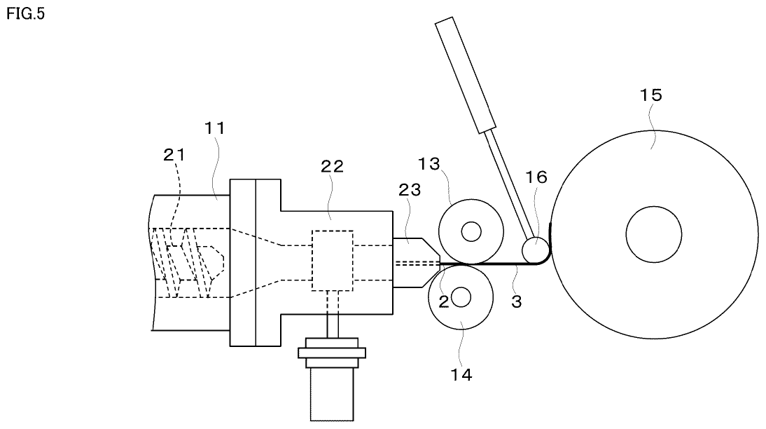

By operating a not-shown movement device, the extruding machine 11 and the forming rollers 13, 14 can be integrally moved in the front-back direction. Even when the extruding machine 11 and the forming rollers 13, 14 are integrally moved in the front-back direction, the positional relationship between the extruding machine 11 and the forming rollers 13, 14 does not change. When the extruding machine 11 and the forming rollers 13, 14 are at the foremost attaching positions in a movement area as shown in FIG. 4, the rubber strip 3 can be sandwiched between the upper forming roller 13 and the molding drum 15. When the extruding machine 11 and the forming rollers 13, 14 are in back in the movement area, there is a space between the forming rollers 13, 14 and the molding drum 15 as shown in FIG. 5.

The outer peripheral surface of the molding drum 15 is in a cylindrical shape. The rubber strip 3 is spirally wound around the outer peripheral surface of the molding drum 15, and in this manner, a cylindrical rubber member for a tire is molded. Examples of the cylindrical rubber member include an inner liner and a squeegee. The rotation axis 15a of the molding drum 15 extends perpendicularly to the front-back direction and horizontally. The molding drum 15 rotates in an upward direction at a location where the molding drum 15 faces the forming rollers 13, 14. The molding drum 15 rotates at a constant speed.

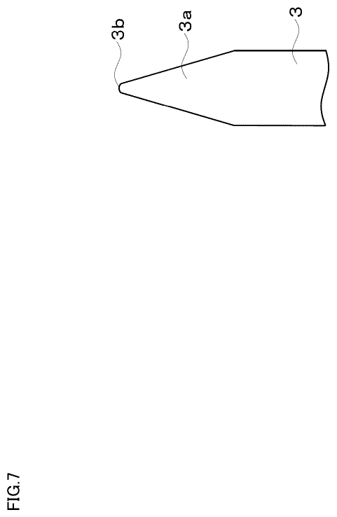

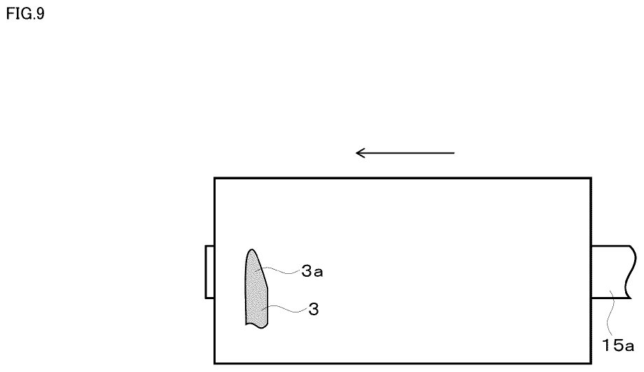

The outer peripheral surface of the molding drum 15 is formed in such a manner that a plurality of metal segments long in the axial direction (hereinafter referred to as a “drum axial direction”) of the molding drum 15 is disposed in a drum circumferential direction. The rubber strip 3 is more easily attached to at least a predetermined portion of the outer peripheral surface of the molding drum 15 than the outer peripheral surface of the upper forming roller 13. The predetermined portion is a portion to which a leading portion 3a (see FIGS. 7 and 9) of the rubber strip 3 having reached the molding drum 15 is attached. Of the predetermined portion, a length in the drum axial direction is the width of the rubber strip 3 or more, and a length in the drum circumferential direction is the length of the leading portion 3a or more. In order to easily attach the rubber strip 3, for example, the predetermined portion has lower surface roughness (for example, arithmetic average roughness Ra or maximum height roughness Rz) than that of the outer peripheral surface of the upper forming roller 13. Thus, rubber adhesion is enhanced. It can be said that the predetermined portion is a portion at which attaching of the rubber strip 3 starts.

Note that a wider area of the molding drum 15 including the predetermined portion may be a portion to which the rubber strip 3 is easily attached, or the entirety of the outer peripheral surface may be a portion to which the rubber strip 3 is easily attached.

The pressing roller 16 is a pressing device for pressing the rubber strip 3 on the molding drum 15. The pressing roller 16 is movable back and forth relative to the molding drum 15. As shown in FIG. 4, when the forming rollers 13, 14 are at the attaching positions, the pressing roller 16 is separated from the molding drum 15. When the forming rollers 13, 14 are moved back and a clearance between the forming rollers 13, 14 and the molding drum 15 is increased as shown in FIG. 5, the pressing roller 16 moves to between the forming rollers 13, 14 and the molding drum 15 and reaches a pressing position close to the molding drum 15. The pressing roller 16 at the pressing position can press the rubber strip 3 on the molding drum 15.

In the rubber member molding apparatus 10 having the above-described configuration, a rubber member molding method described next is performed based on control by the controller.

In the member molding method by the rubber member molding apparatus 10, the raw rubber sheet 1 pulled out of the bobbin 17 is injected into the inlet 25 of the extruding machine 11 by way of the let-off device 12. The raw rubber sheet 1 injected into the barrel 20 through the inlet 25 is kneaded by the rotating screw 21. The kneaded rubber reaches the opening end 24 of the nozzle 23. Before the start of extrusion of the extrusion rubber 2 from the extruding machine 11, the extruding machine 11 stands by in a state of the nozzle 23 being filled to the opening end 24 with the rubber.

When extrusion of the extrusion rubber 2 from the extruding machine 11 starts, the rubber inside the barrel 20 is extruded as the extrusion rubber 2, which is the long rubber member, forward from the opening end 24 of the nozzle 23. The extruding amount is adjusted by the gear pump 22. The sectional shape of the extruded extrusion rubber 2 is a circular shape.

Before a leading portion of the extrusion rubber 2 reaches the gap 18 between the upper and lower forming rollers 13, 14, each of the forming rollers 13, 14 starts rotating at a constant speed. In the present embodiment, the upper and lower forming rollers 13, 14 rotate in the opposite directions at the same speed.

The extrusion rubber 2 extruded from the opening end 24 of the nozzle 23 enters the gap 18 between the upper and lower forming rollers 13, 14. The extrusion rubber 2 passes through the gap 18 between the upper and lower forming rollers 13, 14, and in this manner, changes its shape into the rubber strip 3 having the same sectional shape as that of the gap 18 between the upper and lower forming rollers 13, 14.

The leading portion 3a of the rubber strip 3 is crushed by the upper and lower forming rollers 13, 14 while passing through the gap 18 between the upper and lower forming rollers 13, 14, and in this manner, turns into a tapered shape as shown in FIG. 7. In description below, the entirety of this tapered portion (portion whose width is gradually narrowed as compared to other portions) will be referred to as the “leading portion 3a”. The leading portion 3a of the rubber strip 3 is in an isosceles triangular shape in which the center of the rubber strip 3 in the width direction thereof protrudes in an extruding direction. The vertex of the protrusion in the extruding direction is a tip end 3b of the leading portion 3a of the rubber strip 3.

The rubber strip 3 having passed through the gap 18 is attached to the upper forming roller 13, and is lifted as the upper forming roller 13 rotates.

When the upper forming roller 13 rotates 90° after the leading portion 3a of the rubber strip 3 has passed through the gap 18, the tip end 3b of the leading portion 3a of the rubber strip 3 reaches the foremost end of the upper forming roller 13. Therebefore, the extruding machine 11 and the forming rollers 13, 14 start integrally moving forward, and the forming rollers 13, 14 reach the attaching positions at the same time as or before or after the tip end 3b of the rubber strip 3 reaches the foremost end of the forming roller 13. When the upper forming roller 13 reaches the attaching position, the leading portion 3a of the rubber strip 3 is sandwiched between the upper forming roller 13 and the attaching start portion of the molding drum 15, as shown in FIG. 4.

As described above, the rubber strip 3 is more easily attached to the attaching start portion of the molding drum 15 than the forming roller 13. Thus, the leading portion 3a of the rubber strip 3 is sandwiched between the forming roller 13 and the attaching start portion of the molding drum 15, and thereafter, is separated from the forming roller 13 and is attached to the molding drum 15.

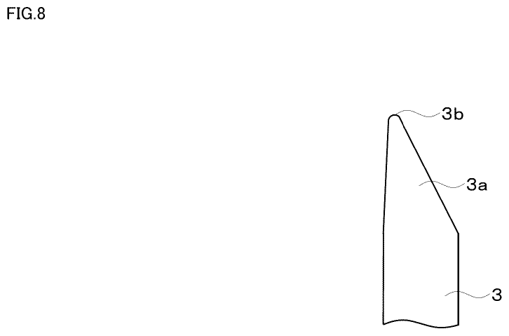

While the leading portion 3a of the rubber strip 3 is being attached to the molding drum 15, the molding drum 15 moves in the drum axial direction at the constant speed. The movement direction is a direction indicated by an arrow in FIG. 9, and is opposite to a direction in which winding of the rubber strip 3 progresses. As shown in FIGS. 8 and 9, by such movement, the tip end 3b (vertex of the isosceles triangular shape) of the rubber strip 3 is moved closer to the outside in the drum axial direction with respect to the center position of the rubber strip 3 in the right-left direction, and the leading portion 3a of the rubber strip 3 is attached to the molding drum 15 with deformed into a right triangular shape having a side in a spirally-winding direction as a hypotenuse. Note that the right-left direction is coincident with the width direction of the rubber strip 3.

After the tip end 3b of the rubber strip 3 has been attached to the molding drum 15, while a portion (e.g., leading portion 3a) subsequent to the tip end 3b is being attached, the extruding machine 11 and the forming rollers 13, 14 are integrally moved back and the upper and lower forming rollers 13, 14 are separated from the molding drum 15. At the same time as or before or after the start of backward movement of the extruding machine 11 and the forming rollers 13, 14, the pressing roller 16 starts moving toward the molding drum 15. Then, when reaching the pressing position, the pressing roller 16 presses the rubber strip 3 attached to the molding drum 15, as shown in FIG. 5.

Thereafter, the molding drum 15 rotates, and the rubber strip 3 is wound around the molding drum 15 accordingly. During winding, the rubber strip 3 attached to the molding drum 15 is continuously pressed by the pressing roller 16.

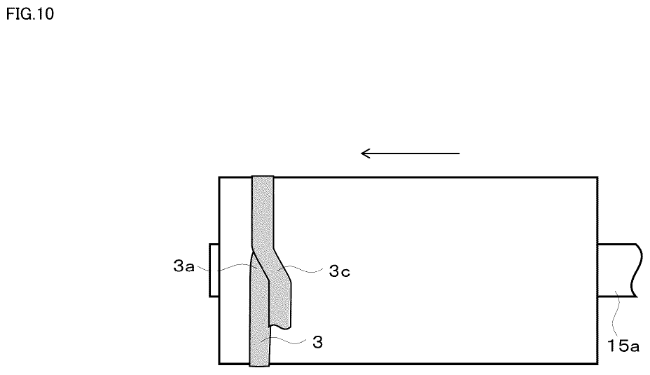

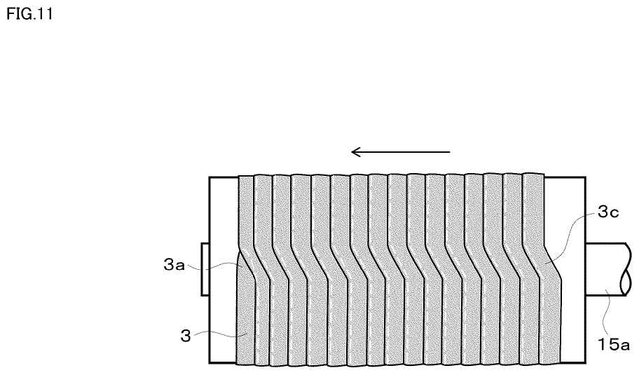

As shown in FIGS. 10 and 11, when the rubber strip 3 is wound around a position overlapping with the leading portion 3a of the rubber strip 3 in the drum axial direction, the molding drum 15 is moved in the drum axial direction, and in this manner, the rubber strip 3 is spirally wound around the molding drum 15. The movement direction of the molding drum 15 is a direction indicated by arrows in FIGS. 10 and 11, and is opposite to the direction in which winding of the rubber strip 3 progresses. While the molding drum 15 is being moved in the drum axial direction, the rubber strip 3 forms an inclined portion 3c attached with inclined with respect to the drum circumferential direction.

Note that when the rubber strip 3 is wound around a region other than the position overlapping with the leading portion 3a of the rubber strip 3 in the drum axial direction, the molding drum 15 does not move in the drum axial direction. Thus, in this region, the rubber strip 3 is wound in the drum circumferential direction. As a result, a portion of the rubber strip 3 other than the inclined portion 3c is wound in parallel with the drum circumferential direction.

At the timing when winding of the rubber strip 3 around the molding drum 15 is about to end, the screw 21 and the gear pump 22 of the extruding machine 11 and the forming rollers 13, 14 are stopped in this order. The gear pump 22 rotates backward only for slight time after the stop of the screw 21, and thereafter, is stopped.

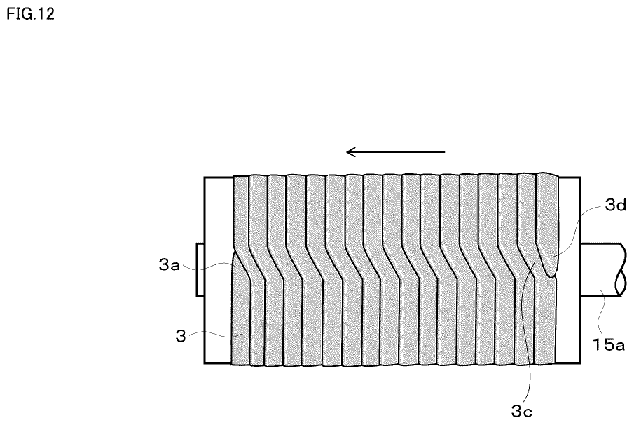

Even after the screw 21 and the gear pump 22 have been stopped and extrusion of the extrusion rubber 2 from the opening end 24 of the nozzle 23 has been stopped, the forming rollers 13, 14 rotate to pull the extrusion rubber 2 forward, thereby cutting the extrusion rubber 2 such that the extrusion rubber 2 is torn at the opening end 24 of the nozzle 23. Such a cut portion turns into a trailing portion 3d (see FIG. 12) of the rubber strip 3 through the gap 18 between the forming rollers 13, 14, and thereafter, the forming rollers 13, 14 are stopped. In this manner, the rubber strip 3 having a length intended to be wound around the molding drum 15 is cut out.

The trailing portion 3d of the rubber strip 3 is cut so as to be torn at the opening end 24 of the nozzle 23 or is crushed by the forming rollers 13, 14, and in this manner, has a tapered shape as in the leading portion 3a. The entirety of such a tapered portion (portion whose width is gradually narrowed as compared to other portions) will be referred to as the “trailing portion 3d”. As in the leading portion 3a of FIG. 7, the trailing portion 3d of the rubber strip 3 is in an isosceles triangular shape in which the center of the rubber strip 3 in the width direction thereof protrudes.

While the trailing portion 3d of the rubber strip 3 is being attached to the molding drum 15, the molding drum 15 moves in the drum axial direction at the constant speed, as indicated by an arrow in FIG. 12. The movement direction is opposite to the direction in which winding of the rubber strip 3 progresses. By such movement, the trailing portion 3d of the rubber strip 3 is attached to the molding drum 15 with deformed into a right triangular shape having a side in the opposite direction of the spirally-winding direction as a hypotenuse as shown in FIG. 12. In this state, the hypotenuse of the trailing portion 3d of the rubber strip 3 is coincident with the inclined portion 3c of the previous turn of the rubber strip 3.

When attaching of the trailing portion 3d of the rubber strip 3 is completed, the cylindrical rubber member for the tire is completed. The width of an overlap of adjacent turns in the drum axial direction is substantially constant from the leading portion 3a to the trailing portion 3d of the rubber strip 3. Each of the leading portion 3a and the trailing portion 3d of the rubber strip 3 also has an overlap with the inclined portion 3c of an adjacent turn of the rubber strip 3, which has a substantially constant width. Thus, the thickness of the cylindrical rubber member is substantially constant, including portions where the leading portion 3a and trailing portion 3d of the rubber strip 3 are attached.

Note that as described above, the extrusion rubber 2 is cut at the opening end 24 of the nozzle 23. Thus, after one strip of the extrusion rubber 2 has been extruded, the extruding machine 11 stands by in a state of the nozzle 23 being filled to the opening end 24 with the rubber until extrusion of a subsequent strip of the extrusion rubber 2 starts.

By repeating the above-described operation, a plurality of cylindrical rubber members is molded.

As described above, the rubber member molding apparatus 10 of the present embodiment has the extruding machine 11 that extrudes the extrusion rubber 2 forward, the upper and lower forming rollers 13, 14 that sandwich the extrusion rubber 2 extruded from the extruding machine 11, and the molding drum 15 to which the rubber strip 3 moved forward after having passed through the gap 18 between the upper and lower forming rollers 13, 14 is attached. In this rubber member molding apparatus 10, the upper forming roller 13 is disposed forward of the lower forming roller 14. Thus, the extrusion rubber 2 extruded from the extruding machine 11 can be received by the lower forming roller 14, be delivered forward on the lower forming roller 14, and be guided to the gap 18 between the upper and lower forming rollers 13, 14. The long rubber member turned into the rubber strip 3 through the gap 18 between the upper and lower forming rollers 13, 14 can be sandwiched between the upper forming roller 13 and the molding drum 15, and therefore, be attached to the molding drum 15. According to the rubber member molding apparatus 10 of the present embodiment, the leading portion 3a of the rubber strip 3 can be attached to the molding drum 15 without the need for a special holding member between the upper and lower forming rollers 13, 14 and the molding drum 15.

The outer peripheral surfaces of the upper and lower forming rollers 13, 14 are in such a relationship that the rubber strip 3 having passed through the gap 18 between the upper and lower forming rollers 13, 14 is attached to the outer peripheral surface of the upper forming roller 13. Thus, the rubber strip 3 having passed through the gap 18 is not attached to the lower forming roller 14, but is attached to the upper forming roller 13. The rubber strip 3 moves to the foremost end of the upper forming roller 13 as the upper forming roller 13 rotates. As a result, the leading portion 3a of the rubber strip 3 can be easily sandwiched between the upper forming roller 13 and the molding drum 15.

The rubber member molding apparatus 10 is provided with the temperature adjustment device, and the temperature adjustment device adjusts the outer peripheral surface of the lower forming roller 14 to the temperature higher than that of the outer peripheral surface of the upper forming roller 13. Thus, the outer peripheral surface of the upper forming roller 13 has adhesion higher than that of the outer peripheral surface of the lower forming roller 14, and therefore, the rubber strip 3 warps upward. Thus, the leading portion 3a of the rubber strip 3 having passed through the gap 18 between the upper and lower forming rollers 13, 14 can be attached to the outer peripheral surface of the upper forming roller 13.

The rubber member molding apparatus 10 is provided with the movement device, and the movement device can move the upper and lower forming rollers 13, 14 in the front-back direction. Thus, when the leading portion 3a of the rubber strip 3 is attached to the molding drum 15, the forming rollers 13, 14 can be moved to the attaching positions forward. When the rubber strip 3 on the molding drum 15 is pressed by the pressing roller 16, the forming rollers 13, 14 can be moved back so as not to interfere with pressing.

The attaching start portion of the outer peripheral surface of the molding drum 15 has low surface roughness, and therefore, rubber adhesion is high. Thus, the rubber strip 3 sandwiched between the upper forming roller 13 and the molding drum 15 can be reliably attached to the molding drum 15.

Various changes can be made to the above-described embodiment. Modifications will be described below.

### <Modification 1>

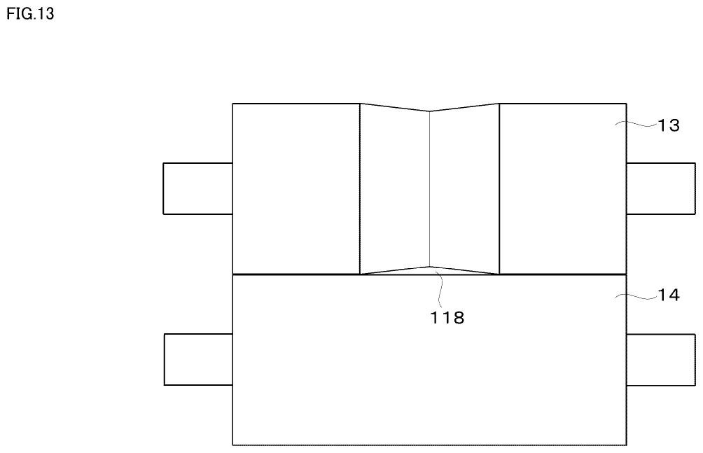

The shape of the gap between the upper and lower forming rollers as viewed in the front-back direction may be a shape other than the trapezoidal shape. Note that the shape of the gap is preferably wide in the upper-lower direction at the center in the right-left direction and narrow in the upper-lower direction on each side in the right-left direction. Examples of such a shape include an isosceles triangular shape as in a gap 118 shown in FIG. 13. In any shape, the gap is preferably configured such that the length in the right-left direction is 20 times or more and 40 times or less the height in the upper-lower direction.

### <Modification 2>

The method for attaching, to the upper forming roller 13, the rubber strip 3 having passed through the gap 18 between the upper and lower forming rollers 13, 14 is not limited to the method of the above-described embodiment.

For example, the outer peripheral surface of the upper forming roller 13 may be more smoothed than the outer peripheral surface of the lower forming roller 14 (i.e., the surface roughness (e.g., arithmetic average roughness Ra or maximum height roughness Rz) is decreased), and in this manner, the outer peripheral surface of the upper forming roller 13 may be formed as a surface to which the long rubber member is more easily attached than the outer peripheral surface of the lower forming roller 14. With this configuration, the rubber strip 3 having passed through the gap 18 between the upper and lower forming rollers 13, 14 can be attached to the upper forming roller 13.

The rotation speed of the upper forming roller 13 may be set higher than the rotation speed of the lower forming roller 14. With this configuration, the rubber strip 3 having passed through the gap 18 between the upper and lower forming rollers 13, 14 can be attached to the upper forming roller 13.

### REFERENCE SIGNS LIST

1: Raw Rubber Sheet
2: Extrusion Rubber
3: Rubber Strip
3a: Leading Portion
3b: Tip End
3c: Inclined Portion
3d: Trailing Portion
10: Rubber Member Molding Apparatus
11: Extruding Machine
12: Let-Off Device
13: Forming Roller
13a: Rotation Axis
13b: Recess
14: Forming Roller
14a: Rotation Axis
15: Molding Drum
15a: Rotation Axis
16: Pressing Roller
17: Bobbin
18: Gap
18a: Bottom
20: Barrel
21: Screw
22: Gear Pump
23: Nozzle
24: Opening End
25: Inlet
118: Gap

What is claimed is:

1. A rubber member molding apparatus comprising:
an extruding machine that extrudes a long rubber member forward;
upper and lower forming rollers that sandwich the long rubber member extruded from the extruding machine; and
a molding drum to which the long rubber member moved forward after having passed through a gap between the upper and lower forming rollers is attached and on which the long rubber member turns into a cylindrical rubber member for a tire, wherein
the upper forming roller is disposed forward of the lower forming roller.

2. The rubber member molding apparatus according to claim 1, wherein
outer peripheral surfaces of the upper and lower forming rollers are in such a relationship that the long rubber member having passed through the gap between the upper and lower forming rollers is attached to the outer peripheral surface of the upper forming roller.

3. The rubber member molding apparatus according to claim 1, further comprising:
a temperature adjustment device that adjusts an outer peripheral surface of the lower forming roller to a temperature higher than that of an outer peripheral surface of the upper forming roller.

4. The rubber member molding apparatus according to claim 1, further comprising:
a controller that controls the rubber member molding apparatus, wherein
under control of the controller, the long rubber member is extruded forward from the extruding machine, the long rubber member extruded from the extruding machine is sandwiched between the upper and lower forming rollers, and the long rubber member moved forward after having passed through the gap between the upper and lower forming rollers is attached to the molding drum and turns into the cylindrical rubber member for the tire, and
the long rubber member is cut at an opening end of a nozzle provided at the extruding machine.

5. The rubber member molding apparatus according to claim 4, wherein the long rubber member is cut in such a manner that the controller stops extrusion of the long rubber member from the extruding machine.

6. The rubber member molding apparatus according to claim 5, wherein
under the control of the controller, the upper and lower forming rollers rotate in directions of moving the long rubber member sandwiched therebetween forward, the upper and lower forming rollers rotate even after stop of extrusion of the long rubber member from the extruding machine, and the long rubber member is cut accordingly.

7. The rubber member molding apparatus according to claim 1, further comprising:
a controller that controls the rubber member molding apparatus, wherein
the gap between the upper and lower forming rollers is formed as a long rubber member supplier,
the controller performs such control that a leading portion of the long rubber member is attached to the molding drum and the long rubber member is wound around the molding drum and turns into a cylindrical rubber member for a tire by rotating the molding drum while the supplier supplies the long rubber member,
the leading portion is in a tapered shape having a tip end,
the controller performs such control that the tip end of the leading portion is moved closer to an outside in a drum axial direction with respect to a center position of the long rubber member in a width direction thereof by moving at least one of the supplier or the molding drum in the drum axial direction upon attaching of the leading portion, and
the controller performs such control that a portion of the long rubber member overlapping with the leading portion in the drum axial direction is formed as an inclined portion inclined with respect to a drum circumferential direction by moving at least one of the supplier or the molding drum in the drum axial direction when the long rubber member is wound around a position overlapping with the leading portion in the drum axial direction and a portion of the long rubber member other than the inclined portion is wound in parallel with the drum circumferential direction.

8. The rubber member molding apparatus according to claim 7, wherein
the long rubber member extruded from the extruding machine passes through the gap formed between the upper and lower forming rollers, and the leading portion turns into a tapered shape accordingly.

9. The rubber member molding apparatus according to claim 7, wherein the leading portion is in an isosceles triangular shape having a tip end at a center position in a width direction, and
the controller performs such control that the leading portion is deformed into a right triangular shape by moving at least one of the supplier or the molding drum in the drum axial direction and moving the tip end of the leading portion closer to the outside in the drum axial direction with respect to the center position of the long rubber member in the width direction thereof when the leading portion is attached to the molding drum.
